(19) United States
(12) Patent Application Publication
(10) Pub. No.: US 2014/0102293 A1
(43) Pub. Date: Apr. 17, 2014

(54) SELF ALIGNING CYLINDER PISTON AND ROD BEARING AND METHOD OF MANUFACTURE THEREOF

(71) Applicant: SPX CORPORATION, Charlotte, NC (US)

(72) Inventors: Douglas P. MILLER, New Berlin, WI (US); Michael T. LANDRUM, Rockford, IL (US); James Ervin COOPER, Menomonee Falls, WI (US)

(73) Assignee: SPX Corporation, Charlotte, NC (US)

(21) Appl. No.: 13/650,697

(22) Filed: Oct. 12, 2012

(51) Int. Cl. F16J 1/00; B23P 15/10

(52) U.S. Cl. 92/172; 29/888.04

(57) ABSTRACT

A piston assembly is provided. The piston assembly may include: a piston rod; a piston pivotally connected to the piston rod; and a rotatable rod bearing configured to allow the piston rod to pass therethough and rotate along with the piston rod as the piston rod pivots with respect to the piston. A method of making a piston assembly may be provided. The method may include: attaching a piston rod to a piston in a pivoting connection; providing a rotatable bearing for the piston rod; and supporting the piston rod with the rotatable bearing.

### FIELD OF THE INVENTION

The present invention relates generally to hydraulic cylinders. More particularly, the present invention relates to a self aligning cylinder piston and rod bearing contained within a hydraulic cylinder.

### BACKGROUND OF THE INVENTION

Hydraulic cylinders (sometimes referred to as rams, jacks or linear actuators) are typically designed with basic components of: a cylinder body, end caps, seals, piston, piston rod and rod bearing. The rod bearing as well as the piston itself act to support any eccentric loading that the cylinder assembly may encounter during use. This eccentric loading, also referred to as side loading, can get quite large. If not properly supported the side loading may result in damage of internal parts of the cylinder.

The rod bearing and piston are typically in fixed alignment with the longitudinal axis of the cylinder, and as side loading is applied, the reaction points of the contact between the piston rod and the rod bearing, as well as the piston to the cylinder walls become concentrated into a point of contact. This reduces the bearing area of the reaction points and the increased stress can easily exceed the load resistance of the cylinder or rod and bearing material. This may cause material to be stressed beyond the yield limits, causing material to be displaced. Galling typically results, which may potentially damage the cylinder.

Accordingly, it is desirable to provide a method and/or apparatus that can perform the functions of a piston and cylinder where forces placed on the piston and/or piston rod may not be exactly parallel to the axis of the piston rod, and distribute the load forces over larger bearing areas. Such a self aligning piston, piston rod, cylinder and rod bearing may be useful.

### SUMMARY OF THE INVENTION

The foregoing needs are met, to a great extent, by the present invention, wherein in one aspect an apparatus is provided that in some embodiments a method and apparatus that provides a self aligning cylinder piston and rod bearing that allows the piston rod to actuate the cylinder when forces acting upon the rod are not exactly parallel to axis of the piston rod without causing the piston rod to move out of alignment within the cylinder. By allowing self aligning rod and piston bearings, more bearing contact area between mating surfaces is achieved, thereby reducing concentrated stress loading.

In accordance with one embodiment of the present invention, a piston assembly is provided. The piston assembly may include: a piston rod; a piston pivotally connected to the piston rod; and a rotatable rod bearing configured to allow the piston rod to pass therethough and rotate along with the piston rod as the piston rod pivots with respect to the piston.

In accordance with another embodiment of the present invention, a method of making a piston assembly may be provided. The method may include: attaching a piston rod to a piston in a pivoting connection; providing a rotatable bearing for the piston rod; and supporting the piston rod with the rotatable bearing.

In accordance with yet another embodiment of the present invention, a piston assembly may be provided. The piston assembly may include: means for pushing a piston; a piston pivotally connected to the means for pushing a piston; and a rotatable bearing means configured to allow the means for pushing a piston to pass therethough and rotate along with the means for pushing a piston as the means for pushing a piston pivots with respect to the piston.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side view of a hydraulic cylinder and piston rod in accordance with an embodiment of the invention.

FIG. 2 is cross-sectional view of a hydraulic cylinder and piston rod according to related art.

FIG. 3 is an enlarged cross-sectional partial view of a hydraulic cylinder and piston rod according to the related art.

FIG. 4 is an enlarged partial cross-sectional view of a hydraulic cylinder and piston rod in accordance with an embodiment of the invention.

FIG. 5 is a cross-sectional perspective view of a portion of a hydraulic cylinder and piston and piston rod in accordance with an embodiment of the invention.

FIG. 6 is a partial perspective cross-sectional view of a hydraulic cylinder and piston rod in accordance with an embodiment of the invention.

### DETAILED DESCRIPTION

The invention will now be described with reference to the drawing figures, in which like reference numerals refer to like parts throughout. An embodiment in accordance with the present invention provides a hydraulic cylinder, piston, and piston rod that is able to withstand forces on the piston rod that are not directly parallel with the axis of the piston rod.

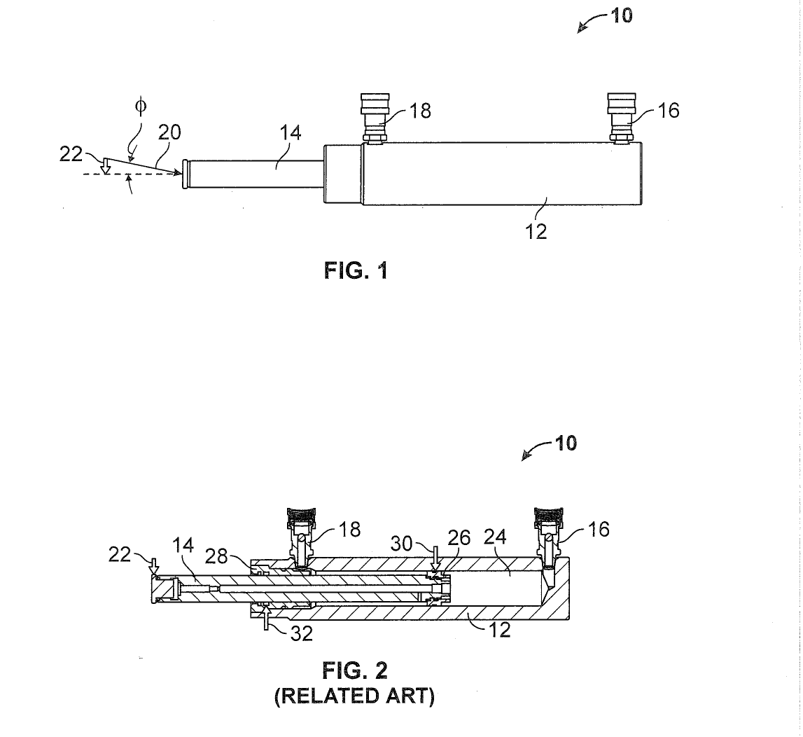

FIG. 1 illustrates a hydraulic cylinder 10. The hydraulic cylinder 10 shown in FIG. 1 can be, according to the present invention, or it could also be according to related art as the internal structures hydraulic cylinder 10 are not shown. The hydraulic cylinder 10 includes a cylinder housing 12 a piston rod 14 and hydraulic inlet/outlet 16 and a hydraulic inlet/outlet 18.

The hydraulic inlets/outlets 16 and 18 are inlets or outlets of hydraulic fluid depending on whether the piston rod 14 is moving inward into the cylinder housing 12 or outward of the cylinder housing 12. For example, when the piston rod 14 is moving inward towards the cylinder housing 12 feature 18 is acting as an inlet for hydraulic fluid into the hydraulic cylinder 10 whereas feature 16 is working as an outlet of hydraulic fluid out of the hydraulic cylinder 10. When the hydraulic fluid is pumped into the feature 16 and the feature 16 acts as an inlet, the hydraulic fluid will push upon the piston (not shown in FIG. 1) connected to the piston rod 14 thereby forcing the piston rod 14 out of the cylinder housing 12. Hydraulic fluid will flow out of the hydraulic cylinder housing 12 through feature 18 which is such case will act as an outlet.

For a variety of reasons, such as, off center loading, tolerances, warping of parts, parts manufactured out of specification or a variety of other reasons, the forces acting on the piston rod 14 may not be parallel to an axis of the hydraulic piston rod 14. Arrow 20 illustrates an exaggerated, example force that may act on the piston rod 14. The piston rod 14 may be connected to a variety of mechanical equipment or other features that are moved when the piston rod 14 moves. The reaction force from this equipment is approximated as a vector and illustrated by arrow 20 in FIG. 1. As can be seen, the force illustrated by vector 20 has a vertical component 22. As shown in FIG. 2, the vertical component 22 acts as a force acting downwardly on the piston rod 14.

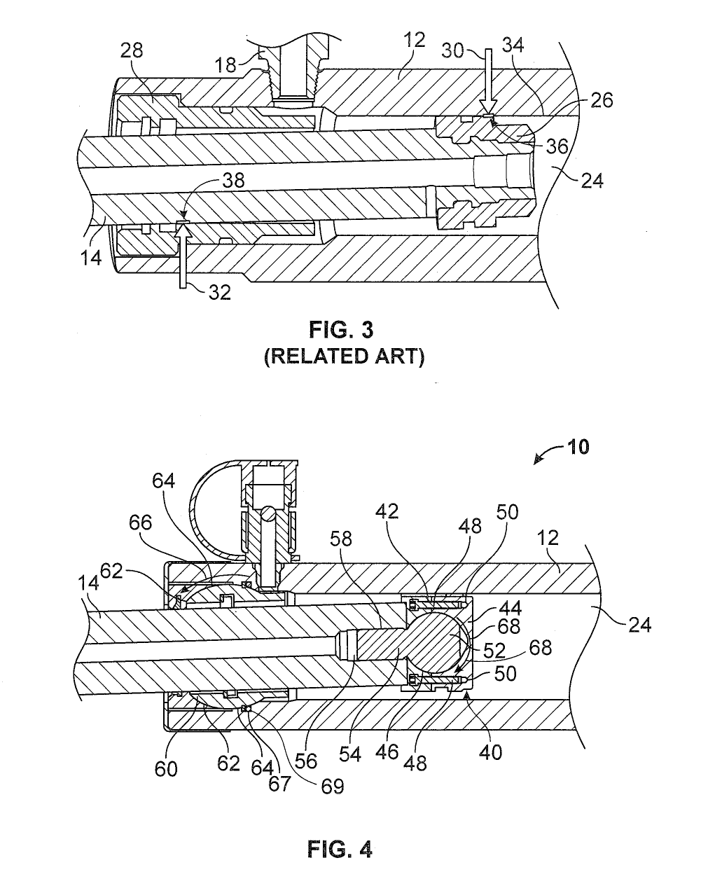

FIG. 2 is a cross-sectional view of hydraulic cylinder 10. The hydraulic cylinder 10 may include an inlet/outlet 16 and 18 and internal bore 24 within the cylinder housing 12. Set within the internal bore 24 is a piston 26. The piston 26 is attached to the piston rod 14. The piston rod 14 is supported in part by the piston 26 and a rod bearing 28. The vertical force component 22 may generate reactionary force components illustrated as force arrows 30 and 32 in FIGS. 2 and 3.

FIG. 3 is an enlarge partial cross-sectional view of the cylinder housing 12 containing the piston 26 and piston rod 14 located within internal bore 24. Inlet/outlet 18 is also shown. The reactionary force arrows 30 and 32 indicate where reactionary forces may be generated to keep the piston rod 14, piston 26 located within the internal bore 24. These reactionary forces 30 and 32 may urge against the wall 34 of the internal bore 24, the piston rod 14, the piston 26 and the rod bearing 28 creating wear points 36 and 38.

As the hydraulic piston 26 and piston rod 14 continue to move in and out of the cylinder housing 12, the wear points 36 and 38 may subject to galling or other types of the undesirable wear along the piston rod 14, the internal bore 24, the piston 26 and/or the bearing 28. In order to avoid or minimize the situation, different types of pistons 40 and rod bearings 60 may be used as shown and described with respect to FIGS. 4, 5, and 6.

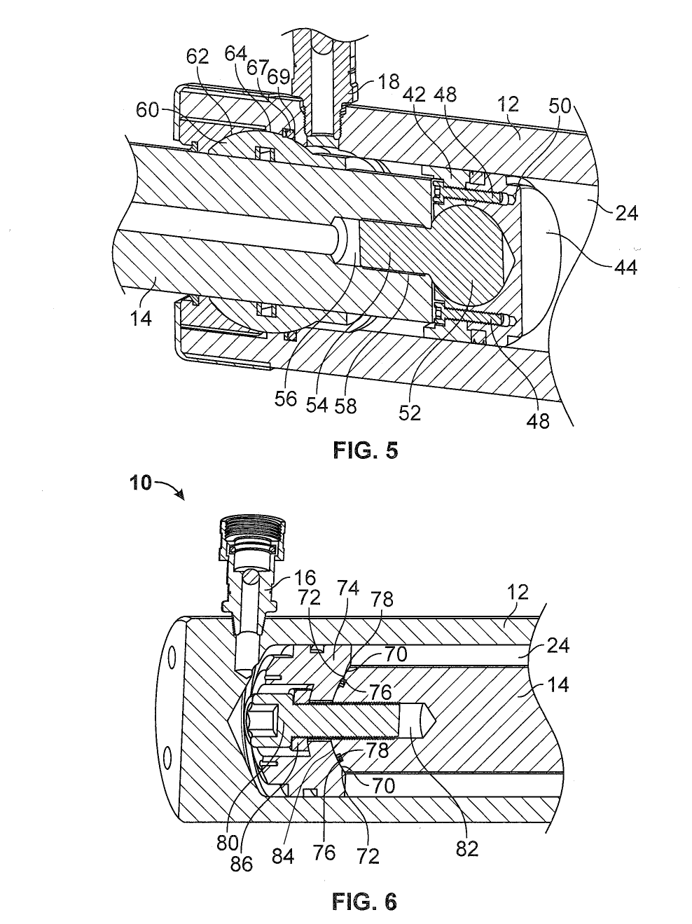

For example, as shown in FIGS. 4 and 5, a piston 40 may be a two part piston 40 and include a front part 42 and rear part 44. The front part 42 and the rear part 44 may define a socket cavity 46. Socket cavity 46 may be generally round or spherical in shape.

Fasteners 48 may attach the front part 42 to the rear part 44 which together comprise the piston 40. The front part 42 and the rear part 44 may include a fastener bore 50 which allow the fasteners 48 to attach the front part 42 and the rear part 44. A ball 52 may be used to connect the piston rod 14 to the piston 40. The ball 52 is attached to a shaft 54. The shaft 54 is located in the bore 56 of the piston rod 14. The shaft 54 may attach to the bore 56 via threads 58 as shown in FIGS. 4 and 5.

However in some embodiments of the invention, other attaching means besides the threads may be used. For example, press fitting, welding or any other suitable way of attaching the ball 52 to the piston rod 14 may be used. The ball 52 is free to move within the socket cavity 46 defined by the front part 42 and rear part 44 of the piston 40, thus enabling the piston rod 14 to pivot with respect to the piston 14 as illustrated by arrow 68.

A rotatable bearing 60 is also used and is able to rotate in order assist or aid in the piston rod 14 pivoting with respect to the piston 40without creating undue wear or galling within the cylinder housing 12 or piston rod 14. The rotatable rod bearing 60 includes a rounded external surface 62. The rotatable rod bearing 60 is contained within a rounded socket 64 within the cylinder housing 12. The rounded surface 62 of the rotatable rod bearing 60 is able to rotate due to the rounded socket 64 in which the rotatable rod bearing 60 is located as illustrated by arrow 66 (see FIG. 4). Thus, the moving or pivoting motions of both the piston rod 14 and the rotatable rod bearing 60 allow the rod bearing 14 to be in a position not exactly square with respect to the piston 40.

However, one of ordinary skill in the art will appreciate after reviewing the disclosure that as the piston rod 14 travels into the cylinder housing 12 it will self align and become more and more square with respect to the piston 40. However, the piston rod 14 moves out of the cylinder housing 12, it can move more and more out of square with respect to the piston 40. The rotatable rod bearing 60 may be equipped with an “O” ring 67 set with a “O” ring groove 69 in order to seal the internal bore 24 with respect to having conditions of hydraulic cylinder 10.

FIG. 6 illustrates a hydraulic cylinder 10 in accordance with another embodiment of the invention. A partial view of the cylinder housing 12 is illustrated in cross-section along with the inlet/outlet 16. Piston rod 14 is located within the internal bore 24.

The piston rod 14 is terminated with a rounded surface 70 on the rod 14. The rounded surface 70 butts against with a corresponding rounded surface 72 on the piston 74. The corresponding rounded surface 70 on the rod 14 and the rounded surface 72 on the piston 74 permit the piston rod 14 to pivot or move with respect to the piston 14 is shown in accordance with the invention and is shown in FIG. 6.

The piston rod 14 may have “O” ring groove 76 and “O” rings 78 contained within them to provide a seal for the area in which the fastener 80 is contained within a fastener hole 82.

The fastener 80 may attach to the piston rod 14 via threads 84 in the fastener hole 82 and on fastener 80. A single fastener 80 along with a resilient washer 86 will permit some movement of the piston rod 14 with respect to the piston 74. The resilient washer 86 may flex when the piston rod 14 moves or pivots with respect to the piston 74.

The embodiment shown in FIG. 6 may also use a rotatable rod bearing 60 like that shown in FIGS. 4 and 5. Because the pivotal rod bearing 60 used in the embodiment shown in FIG. 6 is similar or identical to those shown FIGS. 4 and 5, the rotatable rod bearing 60 will not be shown further described with respect to FIG. 6.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A piston assembly comprising:
a piston rod;
a piston pivotally connected to the piston rod; and
a rotatable rod bearing configured to allow the piston rod to pass therethough and rotate along with the piston rod as the piston rod pivots with respect to the piston.

2. The piston assembly of claim 1, further comprising a cylinder containing the piston, at least part of the piston rod, and the rotatable rod bearing.

3. The piston assembly of claim 2, further comprising a seal located between the rotatable rod bearing and the cylinder.

4. The piston assembly of claim 3, wherein the seal includes an O-ring.

5. The piston assembly of claim 1, wherein the piston defines an internal socket and the piston rod is attached to the piston via a ball joint in the socket.

6. The piston assembly of claim 5, wherein the piston is comprised of two pieces and each piece comprises a part of the socket.

7. The piston assembly of claim 5, wherein the ball joint attaches to the piston rod via threads.

8. The piston assembly of claim 1, wherein the piston rod terminates with a convex surface that contacts a concave surface of the piston and the convex surface of the piston rod rubs against the concave surface of the piston to allow the piston rod to pivot with respect to the piston.

9. The piston assembly of claim 8, further comprising a fastener connecting the piston to the piston rod.

10. The piston assembly of claim 9, further comprising a resilient washer located between a head of the fastener and the piston.

11. The piston assembly of claim 1, wherein the rotatable rod bearing has a spherical outer profile.

12. A method of making a piston assembly comprising:
attaching a piston rod to a piston in a pivoting connection;
providing a rotatable bearing for the piston rod; and
supporting the piston rod with the rotatable bearing.

13. The method of claim 12, further comprising rotating a ball on the piston rod in a socket in the piston.

14. The method of claim 12, further comprising sliding the piston rod through the rotatable bearing.

15. The method of claim 12, further comprising attaching two pieces of the piston defining the socket around the ball.

16. The method of claim 12, further comprising attaching the ball to the piston rod.

17. The method of claim 12, further comprising butting a convex portion of the piston rod against a concave portion of the piston.

18. The method of claim 12, further comprising attaching the piston to the piston rod with a fastener tightened against a resilient washer.

19. The method of claim 12, wherein the rod bearing has a substantially rounded our wall and sits in a cavity complimentary dimensioned to allow the rod bearing to rotate in place.

20. A piston assembly comprising:
means for pushing a piston;
a piston pivotally connected to the means for pushing a piston; and
a rotatable bearing means configured to allow the means for pushing a piston to pass therethough and rotate along with the means for pushing a piston as the means for pushing a piston pivots with respect to the piston.
